(19) United States
(12) Patent Application Publication
(10) Pub. No.: US 2014/0313428 A1
(43) Pub. Date: Oct. 23, 2014

(54) IMAGE DISPLAY APPARATUS, COOLING UNIT, AND COOLING METHOD

(71) Applicant: Sony Corporation, Tokyo (JP)

(72) Inventors: Miki Tsuchiya, Tokyo (JP); Takashi Kato, Tokyo (JP); Yoshihiko Okamura, Chiba (JP); Shinji Yamamura, Chiba (JP); Naoyuki Ebihara, Kanagawa (JP)

(73) Assignee: Sony Corporation, Tokyo (JP)

(21) Appl. No.: 14/249,738

(22) Filed: Apr. 10, 2014

(30) Foreign Application Priority Data
Apr. 19, 2013 (JP) 2013-088117

(51) Int. Cl. G02F 1/1333

(52) U.S. Cl. CPC G02F 1/133385
USPC 349/5; 349/161

(57) ABSTRACT

An image display apparatus includes at least one light modulation device, an outer frame portion, and a cooling portion. The at least one light modulation device is configured to modulate light coming from a light source unit. The outer frame portion is arranged around the at least one light modulation device to enclose the at least one light modulation device. The cooling portion includes a base portion, a heat reception portion, and a heat discharge portion. The base portion is connected to the outer frame portion to enclose the at least one light modulation device. The heat reception portion is configured to receive internal heat on an inside of the base portion. The heat discharge portion is thermally connected to the heat reception portion and configured to discharge the internal heat on an outside of the base portion.

### CROSS REFERENCE TO RELATED APPLICATIONS

This application claims the benefit of Japanese Priority Patent Application JP 2013-088117 filed Apr. 19, 2013, the entire contents of which are incorporated herein by reference.

### BACKGROUND

The present disclosure relates to an image display apparatus such as a projector, a cooling unit, and a cooling method.

Image display apparatuses such as projectors have been widely used from the past. For example, light coming from a light source is modulated by a light modulation device such as a liquid crystal device, and the modulated light is projected on a screen or the like to display an image. As the light modulation device, a reflective-type liquid crystal display device, a transmission-type liquid crystal device, a DMD (Digital Micromirror Device), and the like are used.

In recent years, the use of the projectors in the field of digital cinemas has been conceived. Japanese Patent Application Laid-open No. 2009-48043 discloses a technique for achieving the enhancement of the image quality and the cooling capacity of such projectors that are assumed to be applied to the field of digital cinemas.

### SUMMARY

Such applications of the projectors to the field of digital cinemas are thought to be increasingly widened, and there is a demand for a technique of effectively cooling the image display apparatuses.

In view of the circumstances as described above, there is a need for providing an image display apparatus, a cooling unit, and a cooling method that are capable of performing an effective cooling.

According to an embodiment of the present disclosure, there is provided an image display apparatus including at least one light modulation device, an outer frame portion, and a cooling portion.

The at least one light modulation device is configured to modulate light coming from a light source unit.

The outer frame portion is arranged around the at least one light modulation device to enclose the at least one light modulation device.

The cooling portion includes a base portion connected to the outer frame portion to enclose the at least one light modulation device, a heat reception portion configured to receive internal heat on an inside of the base portion, and a heat discharge portion thermally connected to the heat reception portion and configured to discharge the internal heat on an outside of the base portion.

In the image display apparatus, the outer frame portion and the base portion of the cooling portion are connected to each other so as to enclose the at least one light modulation device. The cooling portion includes the heat reception portion configured to receive the internal heat on the inside of the base portion and the heat discharge portion configured to discharge the internal heat on the outside of the base portion. This can prevent dust and the like of the outside from adhering to the light modulation device and can effectively cool the light modulation device.

The cooling portion may include a circulation portion configured to circulate air of the inside and deliver the air to the heat reception portion. This allows the internal heat to be effectively transmitted to the heat reception portion.

The cooling portion may include an outer delivery portion configured to deliver air of the outside to the heat discharge portion. This allows the internal heat to be effectively discharged to the outside.

The circulation portion may include an inner delivery portion configured to deliver the air of the inside to a cooling target object.

This allows the cooling target object to be effectively cooled.

The heat reception portion may include a plurality of fines that extend in a direction corresponding to a traveling direction of the air of the inside, the air being delivered from the circulation portion.

In such a manner, since the extending direction of the fines is set in accordance with the traveling direction of the internal air, the internal air can be efficiently circulated. As a result, this allows the internal heat to be effectively transmitted to the heat reception portion.

The heat discharge portion may include a plurality of fines that extend in a direction corresponding to a traveling direction of the air of the outside, the air being delivered from the outer delivery portion.

With this configuration, the external air can be efficiently transmitted to the heat discharge portion. As a result, this allows the internal heat to be effectively discharged to the outside.

The cooling portion may include a heat sink including an inner fin portion serving as the heat reception portion connected to the base portion, and an outer fin portion serving as the heat discharge portion connected to the base portion.

The image display apparatus may further include an input optical system and an output optical system.

The input optical system is configured to input the light coming from the light source unit to the at least one light modulation device.

The output optical system is configured to output modulated light modulated by the at least one light modulation device to a projection optical system capable of projecting light.

In this case, the outer frame portion and the cooling portion may be configured to enclose the input optical system and the output optical system.

This can prevent dust and the like of the outside from adhering to the input optical system and the output optical system and can effectively cool those optical systems.

According to another embodiment of the present disclosure, there is provided a cooling unit including an outer frame portion, a base portion, a heat reception portion, and a heat discharge portion.

The outer frame portion is arranged around at least one light modulation device to enclose the at least one light modulation device, the at least one light modulation device being configured to modulate light coming from a light source unit.

The base portion is connected to the outer frame portion to enclose the at least one light modulation device.

The heat reception portion is configured to receive internal heat on an inside of the base portion.

The heat discharge portion is thermally connected to the heat reception portion and configured to discharge the internal heat on an outside of the base portion.

According to another embodiment of the present disclosure, there is provided a cooling method including: connecting an outer frame portion arranged around at least one light modulation device and a base portion of a cooling portion to each other to enclose the at least one light modulation device, the at least one light modulation device being configured to modulate light coming from a light source unit; and receiving internal heat on an inside of the base portion by a heat reception portion of the cooling portion and discharging the internal heat on an outside of the base portion by a heat discharge portion thermally connected to the heat reception portion of the cooling portion.

As described above, according to the present disclosure, it is possible to effectively cool the image display apparatus.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a perspective view showing an outer appearance of an image display apparatus according to an embodiment of the present disclosure;

FIG. 2 is a cross-sectional view of the image display apparatus taken along the line A-A of FIG. 1;

FIG. 3 is a cross-sectional view of the image display apparatus taken along the line B-B of FIG. 1 (the line C-C of FIG. 2);

FIG. 4 is an exploded perspective view of a part where a cooling unit according to the embodiment is arranged;

FIG. 5 is a diagram showing a configuration example of an input optical system, one or more light modulation devices, and an output optical system;

FIG. 6 is a diagram for conceptually describing the principle of cooling according to the embodiment;

FIG. 7 is an exploded perspective view of the cooling unit seen from another angle; and

FIG. 8 is a diagram mainly showing a cooling portion of the exploded perspective view of FIG. 7.

### DETAILED DESCRIPTION OF EMBODIMENTS

Hereinafter, embodiments of the present disclosure will be described with reference to the drawings.

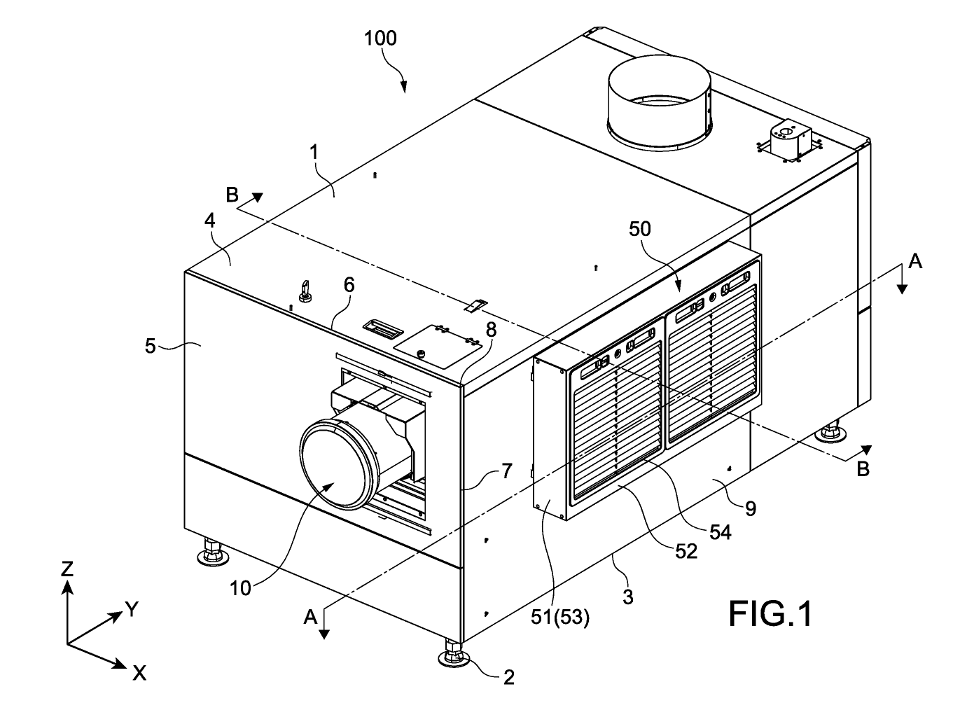

FIG. 1 is a perspective view showing an outer appearance of an image display apparatus according to an embodiment of the present disclosure. An image display apparatus 100 in this embodiment modulates light for each color of red, green, and blue (R, G, and B), that is, red light, green light, and blue light, and combines modulated light (images) of the respective colors with one another, to project a color image for display. The image display apparatus 100 is used as a projector for digital cinemas, but the present disclosure is also applicable to an image display apparatus used for other applications.

As shown in FIG. 1, the image display apparatus 100 includes a main body 1 with a substantially cuboid shape and four support portions 2 that support the main body 1. The long axis direction (y direction) of the main body 1 is a front-back direction and the short axis direction (x direction) of the main body 1 is a horizontal direction. The four support portions 2 are provided at four corners of a lower surface portion 3 being rectangle-shaped (upper surface portion 4 also has substantially the same shape) and stably support the image display apparatus 100. Further, the size in the height direction (z direction) of the support portions 2 may be adjustable, and an angle at which an image is projected may be adjusted.

A front surface portion 5 of the image display apparatus 100 is provided with a projection lens unit 10 for projecting an image on a screen (not shown) or the like. The projection lens unit 10 includes a projection lens and other optical members and enlarges an image at a predetermined magnification for projection on the screen or the like. A specific configuration of the projection lens unit 10 is not limited and may be appropriately designed.

The projection lens unit 10 is arranged in an upper-right end portion when seen from the front of the front surface portion 5. Regarding this right-and-left relationship, the right-hand side when seen from the front is assumed to be the left-hand side of the main body 1, and the left-hand side when seen from the front is assumed to be the right-hand side of the main body 1. Thus, the projection lens unit 10 is provided near a corner portion 8 at which an upper side portion 6 and a left side portion 7 of the front surface portion 5 intersect.

A cooling unit 50 according to an embodiment of the present disclosure is attached to a left surface portion 9 of the main body 1, which is the surface extending backward from the left side portion 7. The cooling unit 50 includes an outer frame portion 51 that has a predetermined width and is formed to have a rectangle shape. With the outer frame portion 51, a flat cuboid shape constituted of two main surface portions 52 and a side wall portion 53 between the main surface portions 52 is formed (the frame portion is to be the side wall portion 53). One of the two main surface portions 52 is arranged to face the left surface portion 9 and the other main surface portion 52 is provided with a ventilation portion 54 for taking in air from the outside.

The cooling unit 50 is arranged at a position corresponding to a position of a cooling target that is provided inside the main body 1. As will be specifically described later, in this embodiment, a predetermined optical component arranged on the rear side of the projection lens unit 10 is a cooling target. So, the cooling unit 50 is arranged at a position of the left surface portion 9, which corresponds to a position of the rear side of the projection lens unit 10. If the position of the cooling target member differs, the position where the cooling unit 50 is arranged also differs. In other words, the position where the cooling unit 50 is attached is not limited to the left surface portion 9 of the main body 1.

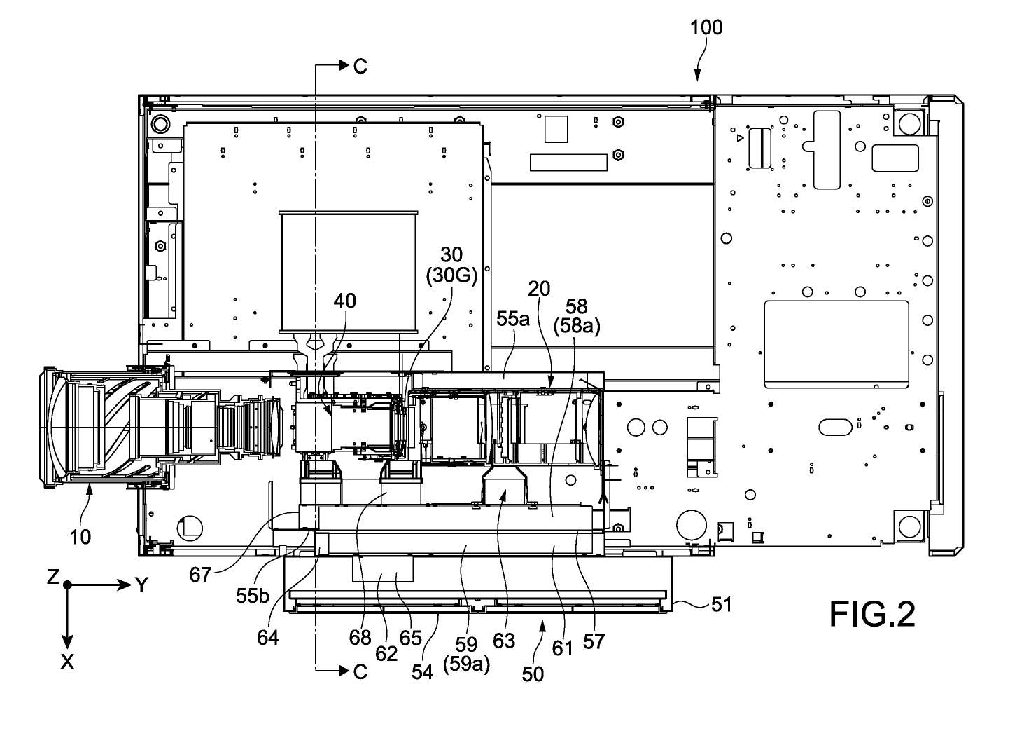

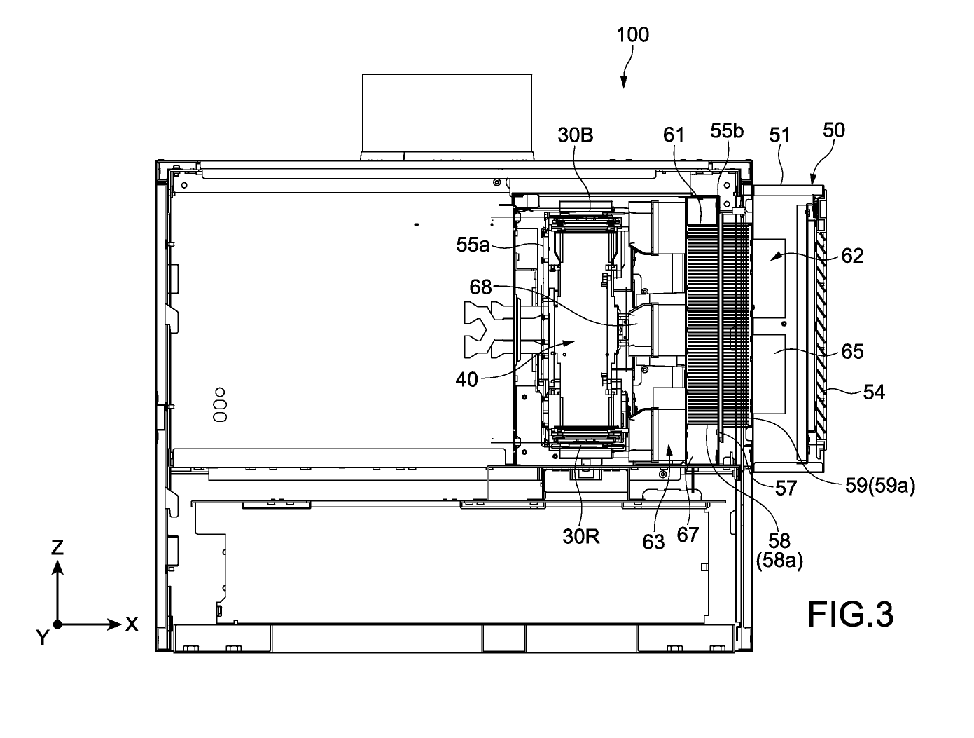

FIG. 2 is a cross-sectional view of the image display apparatus 100 taken along the line A-A of FIG. 1. FIG. 3 is a cross-sectional view of the image display apparatus 100 taken along the line B-B of FIG. 1 (the line C-C of FIG. 2). For simplification of the figures, FIGS. 2 and 3 do not illustrate hatching. Further, in the internal configuration of the image display apparatus 100, portions necessary for the description of the present disclosure are illustrated.

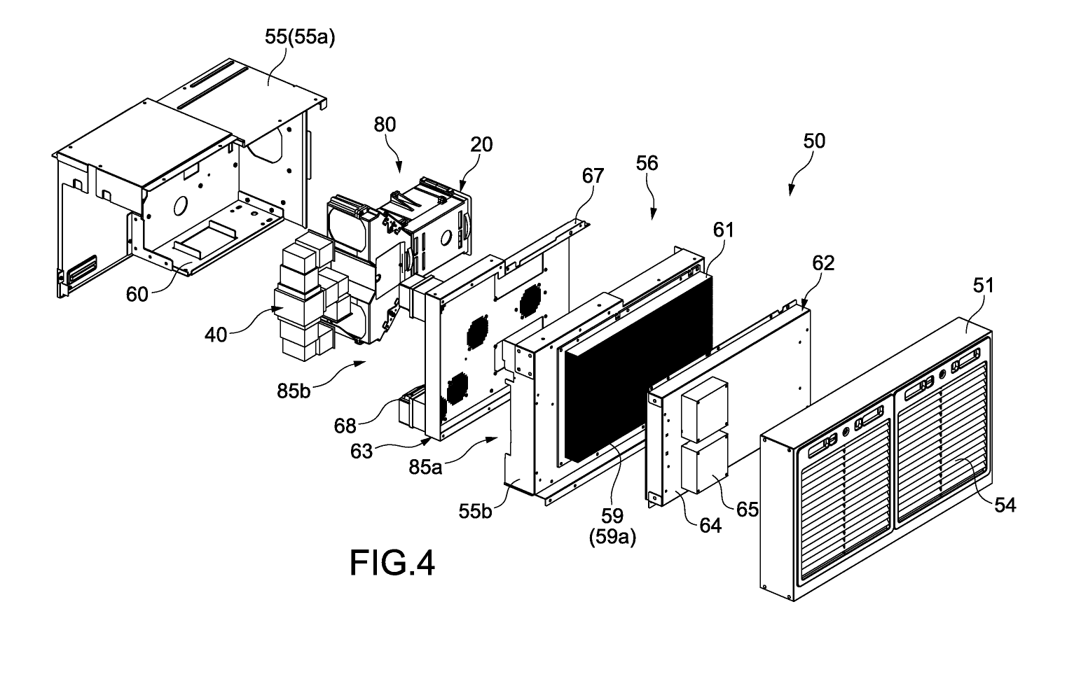

FIG. 4 is an exploded perspective view of a part where the cooling unit 50 is arranged. In FIG. 4, the cooling unit 50 according to this embodiment and an optical member 80 as a cooling target are shown.

As shown in FIG. 2, on the rear side of the projection lens unit 10, a light source unit (not shown), an input optical system 20, one or more light modulation devices 30, and an output optical system 40 are arranged from the rear side to the front side of the image display apparatus 100. In FIG. 2, of the one or more light modulation devices 30, a light modulation device 30G capable of modulating green light is shown. In FIG. 3, light modulation devices 30R and 30B capable of modulating red light and blue light, respectively, are shown. It should be noted that in FIG. 4, the light modulation devices 30 are not shown.

The light source unit outputs white light containing light of R, G, and B. In this embodiment, a laser light source that outputs laser light is used as the light source unit, but the present disclosure is not limited to such a laser light source, and HID (High Intensity Discharge) lamps such as an extra high pressure mercury lamp and a metal halide lamp may be used.

The input optical system 20 inputs the light coming from the light source unit to one or more light modulation devices 30. The one or more light modulation devices 30 modulate the light, which comes from the light source unit and is input by the input optical system 20. The output optical system 40 outputs the modulated light, which is modulated by the one or more light modulation devices 30, to the projection lens unit 10. It should be noted that the projection lens unit 10 corresponds to a projection optical system capable of projecting light.

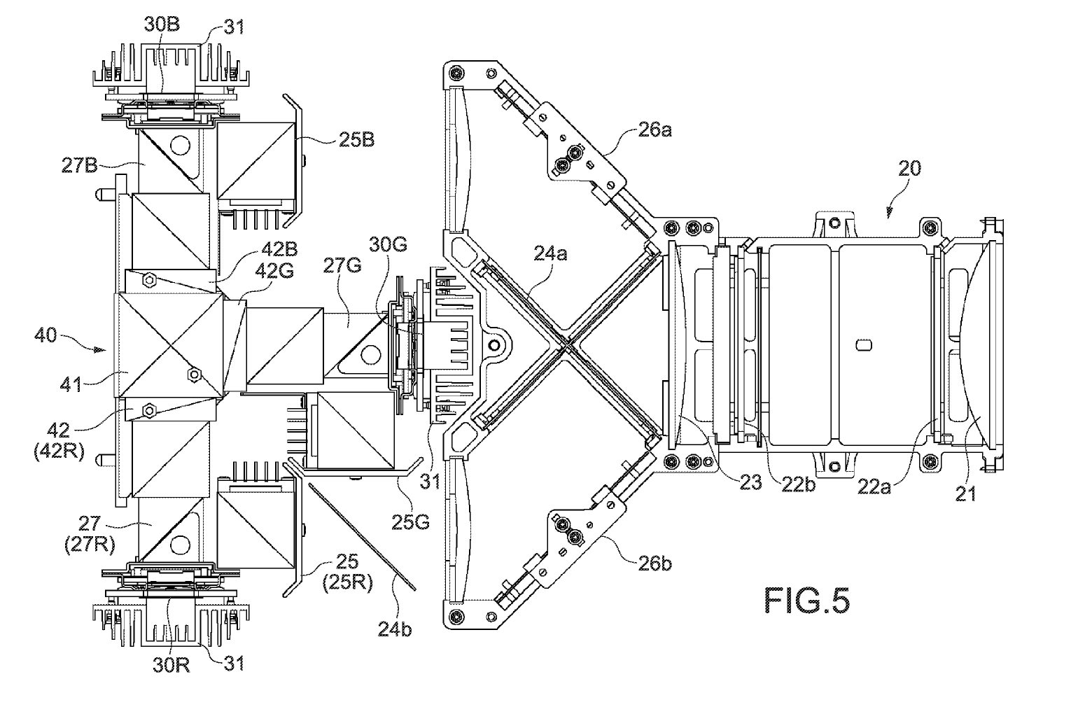

FIG. 5 is a diagram showing a configuration example of the input optical system 20, the one or more light modulation devices 30, and the output optical system 40.

The input optical system 20 includes a collimator lens 21, a first lens array 22a, a second lens array 22b, a superimposing lens 23, a first dichroic mirror 24a, and a second dichroic mirror 24b. Further, the input optical system 20 includes field lenses 25, pre-polarized beam splitters 26a and 26b, and main polarized beam splitters 27. Of those components, three field lenses 25 and three main polarized beam splitters 27 are provided for light of R, G, and B.

In this embodiment, as the one or more light modulation devices 30, three light modulation devices 30R, 30G, and 30B capable of modulating the light of R, G, and B, respectively, are arranged. The light modulation devices 30 modulate the light of R, G, and B based on an image signal supplied from the outside. In this embodiment, a reflective-type liquid crystal device is used as the light modulation device 30, but the configuration of the light modulation device is not limited. For example, another reflective-type light modulation device or transmissive-type light modulation device may be used. In addition, a light modulation device having an optional configuration may be used.

As shown in FIG. 5, in this embodiment, a cooling structure member 31 is formed on the back surface side of each light modulation device 30. The configuration and effect of the cooling structure member 31 are specifically described in above-mentioned Japanese Patent application Laid-open No. 2009-48043 and its contents are included in the disclosed range of the subject application. Further, the cooling structure member 31, other fixing members, and the like can be combined with each light modulation device 30 to be formed as one package.

The output optical system 40 includes the main polarized beam splitters 27, a cross dichroic prism 41, and spacer glasses 42 (42R, 42G, and 42B). In other words, the main polarized beam splitters 27 are members included in both of the input optical system 20 and the output optical system 40. The output optical system 40 is also referred to as a prism block. It should be noted that the configurations of the input optical system 20 and the output optical system 40 are not limited to that shown in FIG. 5 and may be appropriately designed.

The outline of the operation of the optical systems shown in FIG. 5 will be described. The light coming from the light source unit is applied substantially uniformly to the first lens array 22a by the collimator lens 21. A spatial energy distribution of the light is made uniform by the first and second lens arrays 22a and 22b. The light that is output from each cell of the second lens array 22b is superimposed on the light modulation devices 30 by the superimposing lens 23. It should be noted that the light output from the superimposing lens 23 is separated into light of R, G, and B corresponding to the three primary colors by the first and second dichroic mirrors 24a and 24b. Thus, the light of R, G, and B are superimposed on the light modulation devices 30R, 30G, and 30B capable of modulating each light.

The blue light is reflected on the first dichroic mirror 24a and the pre-polarized beam splitter 26a to be input to the field lens 25B. The red light and the green light are reflected on the first dichroic mirror 24a and the pre-polarized beam splitter 26b to be input to the second dichroic mirror 24b. The second dichroic mirror 24b transmits the red light and reflects the green light, thus separating the light. The red light transmitted through the second dichroic mirror 24b is input to the field lens 25R, and the reflected green light is input to the field lens 25G.

The field lenses 25 each have a function of changing illumination light into a telecentric beam and inputting, by its power, the light to the pupil of the projection lens. The light of R, G, and B that are transmitted through the field lenses 25R, 25G, and 25B are input to the main polarized beam splitters 27R, 27G, and 27B, respectively. Each of the main polarized beam splitters 27 transmits and removes a polarized-light component (P-polarized light) unnecessary for the corresponding light modulation device 30 and reflects only a necessary polarized-light component (S-polarized light). Thus, the S-polarized light of the light of R, G, and B are input to the light modulation devices 30R, 30G, and 30B, respectively.

The light modulation devices 30R, 30G, and 30B modulate the light of the colors (S-polarized light) whose polarization directions are aligned with one another by selective polarization control that corresponds to display of each pixel of a two-dimensional video (that is, ON/OFF for each pixel), and output the reflected light constituted of two types of polarized light (P-polarized light and S-polarized light). The light of R, G, and B output from the light modulation devices 30R, 30G, and 30B are input again to the main polarized beam splitters 27R, 27G, and 27B, respectively. Each of the main polarized beam splitters 27 reflects and removes a polarized-light component (S-polarized light) unnecessary for projection and transmits only a polarized-light component (P-polarized light) necessary for projection. Thus, the P-polarized light of the light of R, G, and B are input to the spacer glasses 42R, 42G, and 42B, respectively.

The spacer glasses 42 are bonded to the main polarized beam splitters 27 and the cross dichroic prism 41 and stably and appropriately maintain gaps among those components, to prevent pixel displacements of the respective colors. The light of R, G, and B that are transmitted through the spacer glasses 42R, 42G, and 42B are input to the cross dichroic prism 41 and combined with one another. The projection light combined in the cross dichroic prism 41 is output toward the projection lens unit 10 and projected on the screen or the like.

In this embodiment, the above-mentioned input optical system 20, one or more light modulation devices 30, and output optical system 40 (hereinafter, collectively referred to as a cooling target member 80 in some cases) are cooled by the cooling unit 50. This cooling will be described in detail.

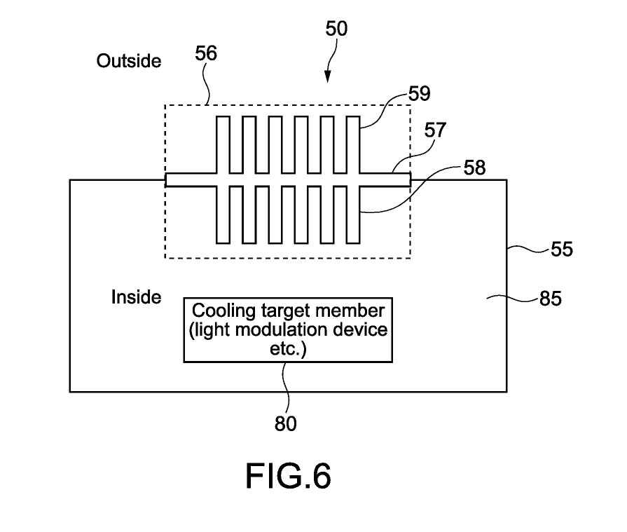

FIG. 6 is a diagram for conceptually describing the principle of cooling according to this embodiment. As shown in FIG. 6, the cooling unit 50 includes an outer frame portion 55 and a cooling portion 56. The outer frame portion 55 is arranged around one or more light modulation devices 30 so as to enclose the one or more light modulation devices 30. In this embodiment, the cooling target member 80 including the input optical system 20 and the output optical system 40 as well is enclosed in the outer frame portion 55.

The cooling portion 56 is attached to the outer frame portion 55. The cooling portion 56 includes a base portion 57 that is connected to the outer frame portion 55 so as to enclose the one or more light modulation devices 30. In other words, the outer frame portion 55 and the base portion 57 of the cooling portion 56 separate the inside and the outside, so that an enclosed space 85 is formed. Thus, the cooling target member 80 including the one or more light modulation devices 30 is enclosed in the space 85 on the inside of the outer frame portion 55.

Further, the cooling portion 56 includes a heat reception portion 58 and a heat discharge portion 59. The heat reception portion 58 is formed on the inside of the base portion 57. The heat discharge portion 59 is formed on the outside of the base portion 57. The heat reception portion 58 receives internal heat on the inside of the base portion 57. The heat discharge portion 59 is thermally connected to the heat reception portion 58 and discharges the internal heat on the outside of the base portion 57. In such a manner, the outer frame portion 55 and the base portion 57 of the cooling portion 56 are connected to each other so as to enclose the one or more light modulation devices 30, the input optical system 20, and the output optical system 40 that are to be cooled. Subsequently, the internal heat generated in the enclosed space 85 is transmitted from the heat reception portion 58 provided on the inside to the heat discharge portion 59 provided on the outside. Subsequently, the heat is discharged from the heat discharge portion 59 to the outside. This can prevent dust and the like of the outside from adhering to the light modulation devices 30, the input optical system 20, and the like and can effectively cool those components.

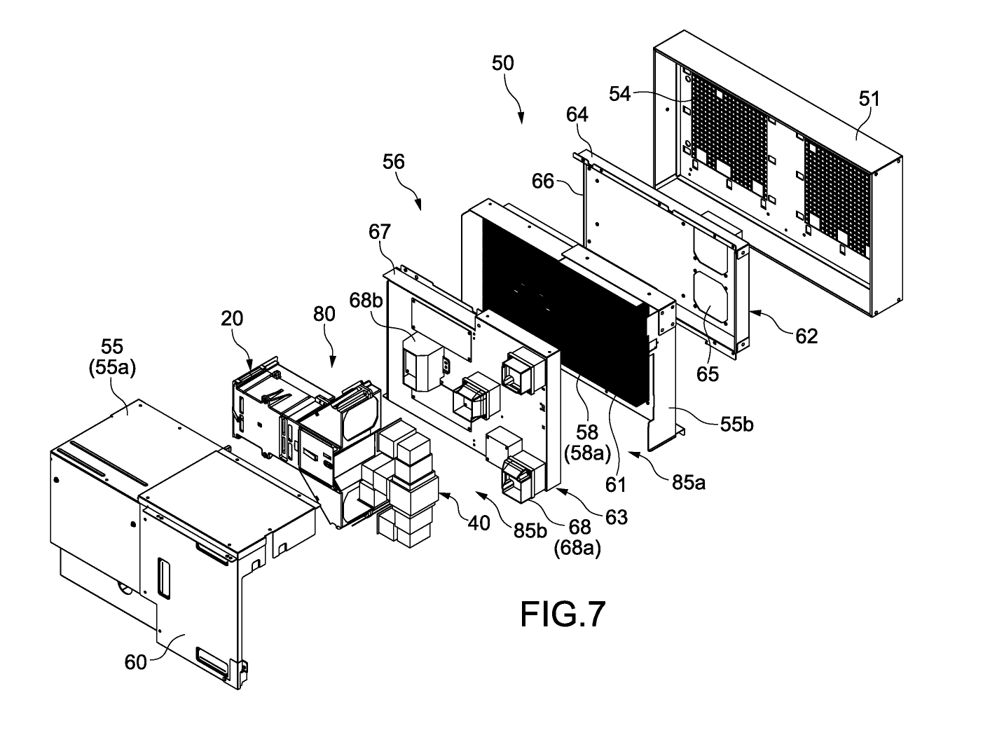

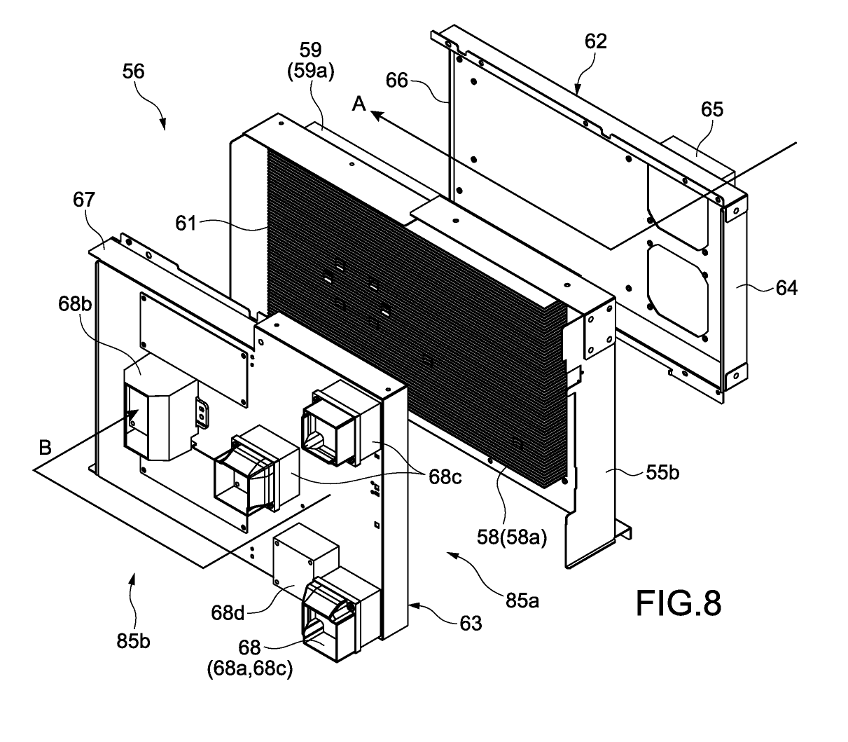

FIG. 7 is an exploded perspective view of the cooling unit 50 seen from another angle. FIG. 8 is a diagram mainly showing the cooling portion 56 of the exploded perspective view of FIG. 7.

As shown in FIGS. 4 and 7, the cooling unit 50 includes, as the outer frame portion 55 described above, a main body portion 55a and an attachment portion 55b. The main body portion 55a is arranged to enclose the cooling target member 80 on the inside of the image display apparatus 100. The main body portion 55a is provided with a wall portion 60 that surround the cooling target member 80 from the inner side, the rear side, and the lower side of the main body portion 55a. The shape and the like of the main body portion 55a are not limited and may be appropriately designed so as to be capable of enclose the cooling target member 80. Further, by using wall portions and the like of other members such as the projection lens unit 10 and the light source unit, the space 85 that encloses the cooling target member 80 may be formed. The material used for the main body portion 55a and the attachment portion 55b is also not limited, and for example, a material with high heat conductivity such as aluminum may be used.

The attachment portion 55b is connected to the main body portion 55a, and the cooling portion 56 is attached to the attachment portion 55b. As shown in FIG. 8, the cooling portion 56 includes a heat sink 61 and an outer cooling portion 62. The heat sink 61 is attached to the attachment portion 55b. The outer cooling portion 62 is arranged so as to cover the heat sink 61 on the outside of the attachment portion 55b. Further, the cooling portion 56 includes an inner cooling portion 63 that is arranged on the inside of the attachment portion 55b. The attachment portion 55b is provided with an opening, and the heat sink 61 is arranged so as to occlude the opening.

The heat sink 61 includes the base portion 57, an inner fin portion (referred to as inner fin portion 58), and an outer fin portion (referred to as outer fin portion 59). The base portion 57 occludes the opening. The inner fin portion 58 serves as the heat reception portion 58 connected to the base portion 57. The outer fin portion 59 serves as the heat discharge portion 59 connected to the base portion 57. The heat sink 61 is referred to as a so-called double-sided heat sink. The base portion 57, the inner fin portion 58, and the outer fin portion 59 are integrally formed of, for example, the material with high heat conductivity such as aluminum and copper. The method of forming the heat sink is not limited, and the heat sink is formed by, for example, corrugated work or press-fitting work.

The inner fin portion 58 and the outer fin portion 59 include a plurality of fins 58a and 59a, respectively. As shown in the cross-sectional views of FIGS. 2 and 3, the exploded perspective view of FIG. 8, and the like, the plurality of fins 58a and 59a extend in the horizontal direction when seen from the ground and in the front-back direction (y direction) of the main body 1. It should be noted that the number of fins is not limited.

The outer cooling portion 62 includes a duct portion 64 and outer fans 65. The duct portion 64 covers the outer fin portion 59. The outer fans 65 are attached to the duct portion 64. The outer fans 65 each function as an outer delivery portion that delivers external air to the outer fin portion 59. The external air taken in by the ventilation portion 54 of FIG. 1 is caused to blow on the outer fin portion 59 via the outer fans 65. As shown in FIG. 8, a discharge port 66 for discharging air is formed on the rear side of the duct portion 64. The external air that is caused to blow on the outer fin portion 59 is discharged from the discharge port 66 to the outside through the ventilation portion 54. Thus, the internal heat of the enclosed space 85, which is transmitted to the outer fin portion 59, can be effectively discharged.

As shown in FIGS. 3 and 4 and the like, the two outer fans 65 are arranged side by side in the height direction on the front side of the duct portion 64. Thus, the air delivered to the outer fin portion 59 is caused to blow on the front side of the outer fin portion 59, travels to the rear side through the gaps between the plurality of fins 59a, and is discharged from the discharge port 66 (see the arrow A). As described above, the plurality of fins 59a are provided to extend in the front-back direction. In other words, the plurality of fins 59a are provided to extend in a direction corresponding to a traveling direction of the external air delivered from the outer fans 65. Thus, the travel of the external air is not prevented and the external air can be efficiently delivered to the outer fin portion 59. As a result, the internal heat can be effectively discharged to the outside. It should be noted that the number and configuration of the outer fans 65 are not limited.

The inner cooling portion 63 includes a base body 67 and inner fans 68 attached to the base body 67. The base body 67 is arranged so as to cover the entire inner fin portion 58 and separates the inner space 85 into two spaces. The two spaces are a space 85a on the inner fin portion 58 side and a space 85b on the cooling target member 80 side. The space 85a on the inner fin portion 58 side is also a heat exchange space in which heat is exchanged, and the space 85b on the cooling target member 80 side is also a cooling target space. Hereinafter, the space 85a on the inner fin portion 58 side is referred to as a first space 85a, and the space 85b on the cooling target member 80 side is referred to as a second space 85b.

As shown in FIG. 8, the inner fans 68 include four delivery fans 68a and one discharge fan 68b. The delivery fans 68a take in the air of the first space 85a and deliver the air to the cooling target member 80. The discharge fan 68b discharges the air delivered by the delivery fans 68a from the second space 85b to the first space 85a. This allows the heat generated from the light modulation devices 30 and the like to be effectively transmitted to the inner fin portion 58. The delivery fans 68a and the discharge fan 68b function as a circulation portion to circulate the internal air and deliver the air to the inner fin portion 58 in this embodiment.

As shown in FIGS. 7 and 8 and the like, the three delivery fans 68c of the four delivery fans 68a are arranged on the front side of the base body 67 so as to form a triangle. Those three delivery fans 68c are arranged in accordance with the positions of the three light modulation devices 30R, 30G, and 30B. Further, the remaining one delivery fan 68d is arranged in accordance with the position of the field lenses 25R and 25G. Thus, in this embodiment, the light modulation devices 30R, 30G, and 30B and the field lenses 25R and 25G are assumed to be cooling target objects, and the four delivery fans 68a are provided so as to cause air to blow on those cooling target objects. Consequently, the influence of heat on the light modulation devices 30 and the like can be prevented.

In such a manner, assuming that a predetermined component in the cooling target member 80 is a cooling target object, the delivery fans 68a may be arranged such that air is caused to blow on the cooling target object. Thus, the cooling target object can be effectively cooled. In this embodiment, the four delivery fans 68a each function as an inner delivery portion that delivers the internal air to the cooling target object. It should be noted that the cooling target object is not limited to the light modulation devices 30 and the field lenses 25 and may be appropriately selected.

The discharge fan 68b is provided on the rear side of the base body 67. So, the air delivered to the three light modulation devices 30R, 30G, and 30B and the field lenses 25R and 25G travels to the rear side through the gaps between the plurality of fins 58a and is delivered to the first space 85a via the discharge fan 68b (see the arrow B). As described above, the plurality of fins 58a are provided to extend in the front-back direction. In other words, the plurality of fins 58a are provided to extend in a direction corresponding to a traveling direction of the internal air that is circulated by the delivery fans 68a and the discharge fan 68b and delivered to the inner fin portion 58. Thus, the travel of the internal air is not prevented and the internal air can be efficiently circulated. As a result, the internal heat can be effectively transmitted to the inner fin portion 58. It should be noted that the number and configuration of the delivery fans 68a and the discharge fan 68b are not limited.

In the case where heat is generated from the cooling target member 80, the internal air is circulated by the delivery fans 68a and the discharge fan 68b, and the internal heat is efficiently transmitted to the inner fin portion 58. The inner fin portion 58 and the outer fin portion 59 are thermally connected to each other, and the external air is caused to efficiently blow on the outer fin portion 59. Since the temperature of the outer fin portion 59 is lowered, the internal heat is transported to the outer fin portion 59 and discharged to the outside. As a result, the temperature of the space 85a on the inner fin portion 58 side is lowered and the air in the space 85a is circulated again by the delivery fans 68a and the discharge fan 68b. Consequently, the cooling target member 80 can be effectively cooled.

Further, in the present disclosure, the cooling target member 80 is enclosed and the heat of the space 85 is discharged to the outside. At that time, the external air is not caused to blow on the cooling target member 80. Thus, dust and the like of the outside can be prevented from adhering to the cooling target member 80. As a result, for example, a problem that the transmittance of the optical system is lowered can be prevented from occurring.

In the case where the image display apparatus is used as a cinema projector, high luminance light is output from a light source, and thus the amount of heat generation in the optical system is increased. Further, large-size lenses and mirrors may be used in many cases. In this situation, in related art, a large amount of wind is caused to directly blow on the optical system from the outside in order to exert a high cooling ability. In such a cooling method, for example, oil of popcorns preferably consumed by viewers of movies adheres to the optical system of the projector, which causes a problem that a video is not displayed appropriately. Additionally, problems of time and effort and costs for the cleaning of the optical system are also caused.

In this embodiment, the cooling target member 80 is enclosed, and thus the problems described above do not occur. Further, not only the light modulation devices 30 but also the input optical system 20, which inputs the light coming from the light source unit to the light modulation devices 30, and the output optical system 40, which outputs the modulated light to the projection lens unit 10, are also enclosed together. As described above, when the large-size optical system is used, the influence of its smear, turbidity, and the like on images becomes large. Thus, when the image display apparatus is used as a cinema projector, it is effective to enclose the optical system from the light source unit to the projection lens unit 10 as in this embodiment. As a matter of course, those effects are exerted also in an image display apparatus used for other applications.

### OTHER EMBODIMENTS

The present disclosure is not limited to the embodiment described above and can achieve any other various embodiments.

In the above description, as shown in FIG. 4, the outer frame portion 55 (including the main body portion 55a and the attachment portion 55b) and the cooling portion 56 form the cooling unit 50. Here, for example, a main body portion provided inside the apparatus may be incorporated in the apparatus in a predetermined shape, and a unit constituted of an attachment portion and a cooling portion may be formed as a cooling unit to be attached to the apparatus. In this case, the cooling unit includes the attachment portion to be a part of an outer frame portion, a base portion connected to the attachment portion, a heat reception portion, and a heat discharge portion.

Alternatively, the entire outer frame portion may be incorporated in the apparatus in advance, and a cooling unit constituted of a cooling portion may be attached to the outer frame portion. In this case, the cooling unit includes a base portion connected to the outer frame portion, a heat reception portion, and a heat discharge portion.

In the above description, the plurality of fines of the outer fin portion and the plurality of fines of the inner fin portion are formed to extend in the front-back direction, but the extending direction of the plurality of fines is not limited thereto. In order that the air may be efficiently caused to blow on the outer fin portion, typically, the extending direction of the plurality of fines of the outer fin portion only needs to be set along the traveling direction of the external air. Further, in order that the internal air may be efficiently circulated, typically, the extending direction of the plurality of fines of the inner fin portion only needs to be set along the traveling direction of the internal air.

The extending direction of the fines of the outer fin portion and the extending direction of the fines of the inner fin portion may be set in different directions. It should be noted that as in the embodiment described above, when the extending directions of the fines of both the fin portions are made uniform, the configuration of the double-sided heat sink functioning as the cooling portion can be simplified, and manufacturing costs and the like can be kept down. Further, when the heat transport direction is made uniform in both the fin portions, the heat transport efficiency can be increased.

As the light source unit, three light sources capable of outputting the light of colors of R, G, and B may be used to apply the light of the colors to the three light modulation devices.

Of the features of the embodiments described above, at least two of the features can be combined to each other.

It should be noted that the present disclosure can have the following configurations.
(1) An image display apparatus, including:
   at least one light modulation device configured to modulate light coming from a light source unit;
   an outer frame portion arranged around the at least one light modulation device to enclose the at least one light modulation device; and
   a cooling portion including
      a base portion connected to the outer frame portion to enclose the at least one light modulation device,
      a heat reception portion configured to receive internal heat on an inside of the base portion, and
      a heat discharge portion thermally connected to the heat reception portion and configured to discharge the internal heat on an outside of the base portion.
(2) The image display apparatus according to (1), in which
   the cooling portion includes a circulation portion configured to circulate air of the inside and deliver the air to the heat reception portion.
(3) The image display apparatus according to (1) or (2), in which
   the cooling portion includes an outer delivery portion configured to deliver air of the outside to the heat discharge portion.
(4) The image display apparatus according to (2) or (3), in which
   the circulation portion includes an inner delivery portion configured to deliver the air of the inside to a cooling target object.
(5) The image display apparatus according to any one of (2) to (4), in which
   the heat reception portion includes a plurality of fines that extend in a direction corresponding to a traveling direction of the air of the inside, the air being delivered from the circulation portion.
(6) The image display apparatus according to any one of (3) to (5), in which
   the heat discharge portion includes a plurality of fines that extend in a direction corresponding to a traveling direction of the air of the outside, the air being delivered from the outer delivery portion.
(7) The image display apparatus according to any one of (1) to (6), in which
   the cooling portion includes a heat sink including
      an inner fin portion serving as the heat reception portion connected to the base portion, and
      an outer fin portion serving as the heat discharge portion connected to the base portion.
(8) The image display apparatus according to any one of (1) to (7), further including:
   an input optical system configured to input the light coming from the light source unit to the at least one light modulation device; and
   an output optical system configured to output modulated light modulated by the at least one light modulation device to a projection optical system capable of projecting light, in which
   the outer frame portion and the cooling portion are configured to enclose the input optical system and the output optical system.

It should be understood by those skilled in the art that various modifications, combinations, sub-combinations and alterations may occur depending on design requirements and other factors insofar as they are within the scope of the appended claims or the equivalents thereof.

What is claimed is:

1. An image display apparatus, comprising:
at least one light modulation device configured to modulate light coming from a light source unit;
an outer frame portion arranged around the at least one light modulation device to enclose the at least one light modulation device; and
a cooling portion including
a base portion connected to the outer frame portion to enclose the at least one light modulation device,
a heat reception portion configured to receive internal heat on an inside of the base portion, and
a heat discharge portion thermally connected to the heat reception portion and configured to discharge the internal heat on an outside of the base portion.

2. The image display apparatus according to claim 1, wherein
the cooling portion includes a circulation portion configured to circulate air of the inside and deliver the air to the heat reception portion.

3. The image display apparatus according to claim 1, wherein
the cooling portion includes an outer delivery portion configured to deliver air of the outside to the heat discharge portion.

4. The image display apparatus according to claim 2, wherein
the circulation portion includes an inner delivery portion configured to deliver the air of the inside to a cooling target object.

5. The image display apparatus according to claim 2, wherein
the heat reception portion includes a plurality of fines that extend in a direction corresponding to a traveling direction of the air of the inside, the air being delivered from the circulation portion.

6. The image display apparatus according to claim 3, wherein
the heat discharge portion includes a plurality of fines that extend in a direction corresponding to a traveling direction of the air of the outside, the air being delivered from the outer delivery portion.

7. The image display apparatus according to claim 1, wherein
the cooling portion includes a heat sink including
an inner fin portion serving as the heat reception portion connected to the base portion, and
an outer fin portion serving as the heat discharge portion connected to the base portion.

8. The image display apparatus according to claim 1, further comprising:
an input optical system configured to input the light coming from the light source unit to the at least one light modulation device; and
an output optical system configured to output modulated light modulated by the at least one light modulation device to a projection optical system capable of projecting light, wherein
the outer frame portion and the cooling portion are configured to enclose the input optical system and the output optical system.

9. A cooling unit, comprising:
an outer frame portion arranged around at least one light modulation device to enclose the at least one light modulation device, the at least one light modulation device being configured to modulate light coming from a light source unit; and
a base portion connected to the outer frame portion to enclose the at least one light modulation device;
a heat reception portion configured to receive internal heat on an inside of the base portion; and
a heat discharge portion thermally connected to the heat reception portion and configured to discharge the internal heat on an outside of the base portion.

10. A cooling method, comprising:
connecting an outer frame portion arranged around at least one light modulation device and a base portion of a cooling portion to each other to enclose the at least one light modulation device, the at least one light modulation device being configured to modulate light coming from a light source unit; and
receiving internal heat on an inside of the base portion by a heat reception portion of the cooling portion and discharging the internal heat on an outside of the base portion by a heat discharge portion thermally connected to the heat reception portion of the cooling portion.
